(19) United States
(12) Patent Application Publication
(10) Pub. No.: US 2013/0297693 A1
(43) Pub. Date: Nov. 7, 2013

(54) ONLINE MOBILE AND NETWORKING PLATFORM WITH USER PROFILE AND GROUP FEATURES

(71) Applicant: DEETS, INC., Westport, CT (US)

(72) Inventors: Linda Miller, Westport, CT (US); Luke Scott, Bridgeport, CT (US); Art Goldberg, Mountain View, CA (US); Jeff Pilz, Madison, CT (US); Mark Bonano, Ansonia, CT (US); Aaron Junod, Vernon, CT (US)

(73) Assignee: deets, Inc., Westport, CT (US)

(21) Appl. No.: 13/840,067

(22) Filed: Mar. 15, 2013

Related U.S. Application Data
(60) Provisional application No. 61/643,804, filed on May 7, 2012.

(51) Int. Cl. G06F 15/16

(52) U.S. Cl. CPC H04L 67/306
USPC 709/204

(57) ABSTRACT

There is provided a method for selectively providing profile information to various group members of various groups while utilizing a user name identifier for each group that is independent of another user name identifier. According to another aspect of the invention there is provided a method for dynamically updating profile information of a first user with a native contact manager associated with communications applications of various group members. According to another aspect of the invention there is provided a method for with group members without the group members being notified of the other group members having also received an electronic communication.

### CROSS-REFERENCE TO RELATED APPLICATIONS

The present application is a non-provisional patent application of U.S. provisional patent application, Ser. No. 61/643,804 entitled ONLINE AND MOBILE NETWORKING PLATFORM WITH USER PROFILE AND GROUP FEATURES, filed on May 7, 2012, and claims of benefit of such earlier filing date of such parent provisional application the entire contents of which are hereby incorporated by reference.

### STATEMENT RE: FEDERALLY SPONSORED RESEARCH/DEVELOPMENT

Not Applicable

### BACKGROUND

1. Technical Field

The present disclosure relates generally to online networking platforms, and more particularly, to the methods for selectively providing profile information, dynamically updating profile information, and communicating with group members.

2. Related Art

Online, web-based social networking services are popular across a wide demographic of users, and the field in general is experiencing substantial growth. At the most basic level, social networking involves connecting users with each other to communicate and share information. Users typically establish user accounts and create user profiles containing contact information and biographic data such as current location, education, employment experiences, personal relationships, telephone numbers, email addresses, and so forth. Furthermore, various updates of interest with messages, photographs, videos, and links to other sites may be posted on the user profile. Access to this personal information may be limited to others that have approved and set up links with the user account. Depending on preference, information of limited privacy concern may be made accessible to secondary contact links, or to all users on the social networking service. A group of contacts, which can minor the user's real-life personal network, may thus be established online, and a variety of content can be exchanged.

There are a few popular large-scale social networking services that offer many features, customization options, and privacy/sharing settings. Among the most popular for general social networking purposes is Facebook, which currently has over 1 billion users worldwide. Also popular, but for the most part limited to business related networking, is LinkedIn, which currently has approximately 200 million users.

Although content sharing functions are available on and are still widely used in such general purpose social networking services, much of the newer development in social networking have narrower function sets. However, substantial development efforts have been focused on usability and accessibility improvements thereto. Service developers have thus endeavored to make those functions available in a mobile environment, typically in the form of applications or “apps” downloadable to the users' mobile devices.

One of the limitations associated with existing state of the art is that the aforementioned social networking services are restricted to independent data silos. In other words, data sharing between the social networking services is limited, and establishing a network of contacts requires users to do so in the context of those individual services. The privacy settings, defaults, and policies may differ substantially from one service to another, which can make data sharing a challenge. Some efforts have been made to combine the user-generated content, but these have so far been limited to “dashboard” type applications that simply pull the data from each service to display to the user. In some cases, application programming interfaces (APIs) can be used to cross-post content originating from one service and displaying the same within the same structure and framework of a host service.

Moreover, a given user may have their own personal computing devices, workstations, laptops, smart phones, etc., that each have a native contact manager. A native contact manager is a software program or application that allows for the organization and storage of contact information and data of various contacts. Thus, a given user may have contact information and data of a given contact that is divergent from certain contact information and data that is for the same contact as accessed via any number of online social networking services.

Accordingly, there is a need in the art for an online networking platform that may facilitate selectively providing profile information, dynamically updating profile information, and communicating with group members so as to allow a user improved control of their data and data sharing with their contact.

### BRIEF SUMMARY

In accordance with various embodiments of the present disclosure, there is provided a method for selectively providing profile information. The method includes establishing a first user account for a first user via an online networking platform. The first user account includes a unique account identifier and a first user master profile with profile information elements. The method further includes establishing, via the online networking platform, the first user in a plurality of groups. Each group includes multiple group members. The method further includes receiving from the first user, via the online networking platform, a group profile for each group to be accessible to group members for each group. Each group profile is a designation of any of the profile information elements. Each group profile includes a user name identifier. Each user name identifier is independent of another user name identifier. The method further includes transmitting, from the online networking platform, the profile information elements to a group member of a particular group based upon the group profile for that group.

According to various embodiments, the online networking platform may include a computer server in operable communication with a computer network. Further, the plurality of groups may include a first group and second group. The step of receiving from the first user may further include receiving a group profile for the first group and the second group with the first group including a user name identifier different than a user name identifier of the second group.

According to another embodiment there is provided a method for dynamically updating profile information. The method includes establishing a first user account for a first user via an online networking platform, the first user account including first user profile information. The method further includes receiving, via the online networking platform, a master user list of a plurality of group members. Each of the group members has a user account with the online networking platform. Each of the group members has an associated communications device. Each communications device includes a communications application and a native contact manager. Each communications application is configured to communicate with the online networking platform. The method further includes receiving, via the online networking platform, a sub-set user list identifying group members of the master user list. The method further includes receiving, via the online networking platform, an identification of first user shared information of the first user profile information from the first user and an associated sub-set user list of group members. The method further includes transmitting, from the online networking platform, the first user shared information to each of the communications applications of each of the group members identified in the sub-user list via a first communications protocol for storing the first user shared information with the native contact manager associated with each of the communications applications using a second communications protocol. The method further includes receiving, via the online networking platform, an update to the shared information from the first user. The method further includes integrating the update with the first user shared information to form updated shared information. The method further includes transmitting, from the online networking platform in response to receiving the update the updated shared information to each of the communications applications of each of the group members identified in the sub-set user list via a first communications protocol for storing the updated shared information with the native contact manager associated with each of the communications applications using a second communications protocol.

According to various embodiments, the online networking platform may include a computer server in operable communication with a computer network. A group member may have an associated communications device that is a mobile device with a communications application configured to communicate with the online networking platform.

According to yet another embodiment there is provided a method for communicating with group members. The method includes establishing a first user account for a first user, via an online networking platform, the first user account including first user profile information. The method further includes establishing the creation of a group by the first user, via the online networking platform, the group including the first user and multiple group members, each of the group members having user profile information. The method further includes providing access, via the online networking platform, by the first user to the user profile information of each of the group members. The method further includes providing access, via the online networking platform, to each of the group members to the first user profile information. The method further includes simultaneously transmitting, from the online networking platform, to each of the group members an electronic communication from the first user without the group members being notified of the other group members having also received the electronic communication. The method further includes allowing each of the group members to electronically communicate, via the online networking platform, with the first user independent of other group members.

According to various embodiments, the online networking platform may include a computer server in operable communication with a computer network. The step of simultaneously transmitting may include initiating email communications to each of the group members from the first user without the group members being notified of the other group members having also received the email communications.

According to yet another embodiment, there is provided an article of manufacture comprising a non-transitory program storage medium readable by a data processing apparatus. The medium embodies one or more programs of instructions executable by the data processing apparatus to perform a method for selectively providing profile information. The method includes establishing a first user account for a first user via an online networking platform. The first user account includes a unique account identifier and a first user master profile with profile information elements. The method further includes establishing, via the online networking platform, the first user in a plurality of groups. Each group includes multiple group members. The method further includes receiving from the first user, via the online networking platform, a group profile for each group to be accessible to group members for each group. Each group profile is a designation of any of the profile information elements. Each group profile includes a user name identifier. Each user name identifier is independent of another user name identifier. The method further includes transmitting, from the online networking platform, the profile information elements to a group member of a particular group based upon the group profile for that group.

According to various embodiments, the online networking platform may include a computer server in operable communication with a computer network. The plurality of groups may include a first group and second group. The step of receiving from the first user further may include receiving a group profile for the first group and the second group. The first group may include a user name identifier different than a user name identifier of the second group.

According to another embodiment, there is provided an article of manufacture comprising a non-transitory program storage medium readable by a data processing apparatus. The medium embodies one or more programs of instructions executable by the data processing apparatus to perform a method for dynamically updating profile information. The method includes establishing a first user account for a first user via an online networking platform. The first user account includes first user profile information. The method further includes receiving, via the online networking platform, a master user list of a plurality of group members. Each of the group members has a user account with the online networking platform. Each of the group members has an associated communications device. Each communications device includes a communications application and a native contact manager. Each communications application is configured to communicate with the online networking platform. The method further includes receiving, via the online networking platform, a sub-set user list identifying group members of the master user list. The method further includes receiving, via the online networking platform, an identification of first user shared information of the first user profile information from the first user and an associated sub-set user list of group members. The method further includes transmitting, from the online networking platform, the first user shared information to each of the communications applications of each of the group members identified in the sub-user list via a first communications protocol for storing the first user shared information with the native contact manager associated with each of the communications applications using a second communications protocol. The method further includes receiving, via the online networking platform, an update to the shared information from the first user. The method further includes integrating the update with the first user shared information to form updated shared information. The method further includes transmitting, from the online networking platform in response to receiving the update, the updated shared information to each of the communications applications of each of the group members identified in the sub-set user list via a first communications protocol for storing the updated shared information with the native contact manager associated with each of the communications applications using a second communications protocol.

According to various embodiments, the online networking platform includes a computer server in operable communication with a computer network. A group member may have an associated communications device that is a mobile device with a communications application configured to communicate with the online networking platform.

According to yet another embodiment, there is provided an article of manufacture comprising a non-transitory program storage medium readable by a data processing apparatus. The medium embodies one or more programs of instructions executable by the data processing apparatus to perform a method for communicating with group members. The method includes establishing a first user account for a first user, via an online networking platform. The first user account includes first user profile information. The method further includes establishing the creation of a group by the first user, via the online networking platform. The group includes the first user and multiple group members. Each of the group members has user profile information. The method further includes providing access, via the online networking platform, by the first user to the user profile information of each of the group members. The method further includes providing access, via the online networking platform, to each of the group members to the first user profile information. The method further includes simultaneously transmitting, from the online networking platform, to each of the group members an electronic communication from the first user without the group members being notified of the other group members having also received the electronic communication. The method further includes allowing each of the group members to electronically communicate, via the online networking platform, with the first user independent of other group members.

The online networking platform may include a computer server in operable communication with a computer network. The step of simultaneously transmitting may include initiating email communications to each of the group members from the first user without the group members being notified of the other group members having also received the email communications.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a symbolic diagram illustrating one exemplary networked computing environment in which various embodiments of the present disclosure may be implemented, including an online networking platform;

FIG. 2 is an exemplary user interface of an online networking platform for managing a user profile;

FIG. 3a is an exemplary user interface of mobile device of a user for viewing a user profile of the user;

FIG. 3b is the exemplary user interface of mobile device of a user of FIG. 3a with updated information being made to user profile of the user;

FIG. 4a is an exemplary user interface of mobile device of a group member including contact search screen of a native contact manager;

FIG. 4b is the exemplary user interface of mobile device of a user of FIG. 4a with updated information being made to the user profile of the user in the native contact manager;

FIG. 5 is a symbolic relational diagram of a user and group members featuring communications paths amongst the user and group members;

FIG. 6 is a symbolic relational diagram of a user and group members featuring independent communications paths between the user and the group members;

FIG. 7 is a flowchart illustrating a method for selectively providing profile information in accordance with one embodiment of the present disclosure;

FIG. 8 is a flowchart illustrating a method for dynamically updating profile information in accordance with one embodiment of the present disclosure; and

FIG. 9 is a flowchart illustrating a method for communicating with group members in accordance with one embodiment of the present disclosure.

Common reference numerals are used throughout the drawings and the detailed description to indicate the same elements.

### DETAILED DESCRIPTION

An online networking platform and methods for selectively providing profile information, dynamically updating profile information, and communicating with group members is disclosed. The detailed description set forth below in connection with the appended drawings is intended as a description of the several presently contemplated embodiments of these systems, platforms, and methods, and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

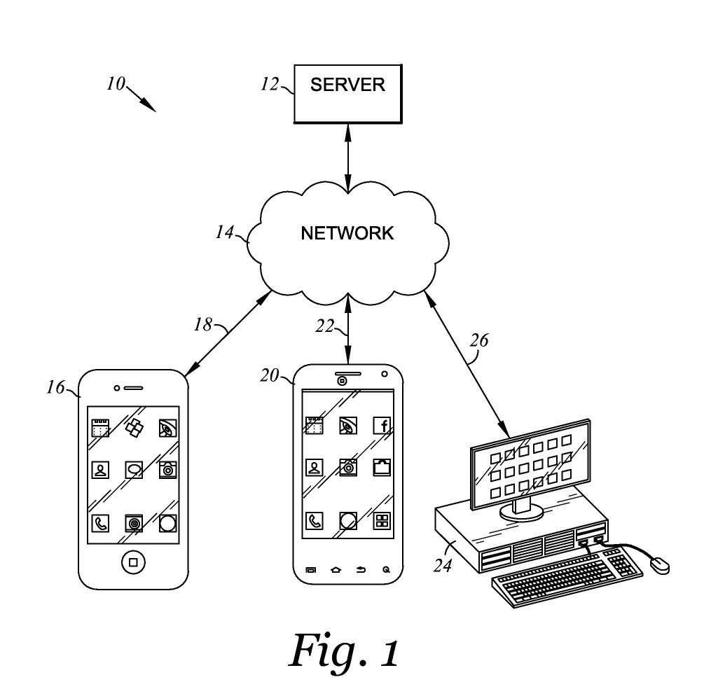

FIG. 1 is a symbolic diagram illustrating one exemplary networked computing environment 10 in which various embodiments of the present disclosure may be implemented. The networked computer environment 10 includes a computer server 12 that includes an online networking platform in accordance with aspects of the present invention. The computer server 12 is in operable communications with a network 14. Generally, there is understood to be a variety of computer systems that are interconnected via a network 14 such as the publicly accessible Internet. While the network 14 is referred to in the broadest sense as encompassing any link over which data communications may be proceed between network nodes, presently, the network 14 solely has the existing infrastructure of independently operated servers for implementing the functionality of the various social networking services accessed in accordance with the present disclosure.

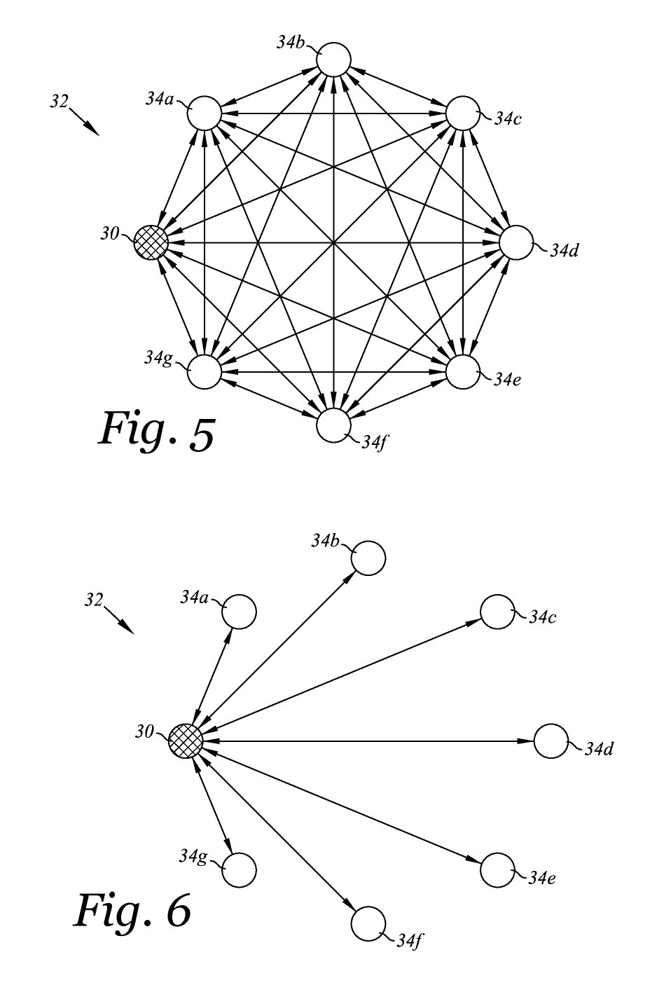

Connected to the network 14 are a first user communications device 16, a second user communications device 20, and a third user communications device 24, as respectively operated or associated with a first user 30, a user 34a and a user 34b (as indicated in FIGS. 5 and 6 as further discussed below). The first user communications device 16 and the second user communications device 20 may each take the form of a smart phone. The first user communications device 16 and the second user communications device 20 may be connectable to the network 14 via network links 18, 22, respectively. The third user communications device 24 may be a conventional personal computer device including a central processing unit, memory, and various input and output devices such as keyboards, mice, and display units. The third user communications device 24 may be connectable to the network 14 via a network link 26. It is understood that such illustrations of the first user communications device 16, a second user communications device 20, and a third user communications device 24, are symbolic in nature and that each such device may be any number of computing devices capable of electronic communications with the network 14, such as a workstation, a tablet computing device, a notebook computer, portable device or any other suitable data processing apparatus that may be implemented functionality contemplated in the present disclosure as described more fully below.

The communications devices 16, 20, 24 may each have executable instructions of a web browser application that are loaded thereon. The web browser applications are configured to communicate with the computer server 12 also connected to the network 14 over the hypertext transfer protocol (HTTP), among other protocols known in the art. Requests for data are initiated by the communications devices 16, 20, 24 and transmitted to the computer server 12, which in turn transmits the requested data back to the communications devices 16, 20, 24. In certain embodiments such as where the communication devices 16, 20, 24 are each a mobile device capable of executing standalone applications, there may not be a need for a specific web browser application. Further, in a conventional desktop computing environment it is also possible to utilize dedicated applications to access the network 14 and the computer server 12 connected thereto. It is understood, however, that such applications also communicate with the computer server 12 over the same protocols (namely, HTTP); though rendering the requested content may not be identical to the way the web browser application renders it. Whether interactions initiated by the communications devices 16, 20, 24 utilize a conventional general-purpose web browser application or a dedicated mobile device application, the computer server 12 performs various steps that embody the methods of the present disclosure, the details of which will be described more fully below.

The computer server 12 may be a World Wide Web (Web) server that processes requests from the client web browser applications and deliver requested Hypertext Markup Language (HTML) pages as briefly described above. The computer server 12 may be computer systems with processors, memory, data storage devices, and network interface devices that run and are managed by an operating system and run web application servers. It will be recognized that in addition to serving static hypertext documents, interactive web-based applications can be implemented on the computer server 12.

It is contemplated that the first user 30 initially establishes a first user account via the online networking platform. The first user account includes a unique account identifier. The first user account would typically also include a password. As is common place with most any online accounts this would be simply understood as the user name and password. The unique account identifier and password would allow the first user 30 to “log on” to the online networking platform in order to access and interact with the first user account. It is contemplated that the first user 30 may be an individual or other entity that utilizes the unique account identifier to establish or access the account or is otherwise the account holder. It will be appreciated that an arbitrary number of user accounts may be established on the online networking platform, and need not be limited to the example first user 30.

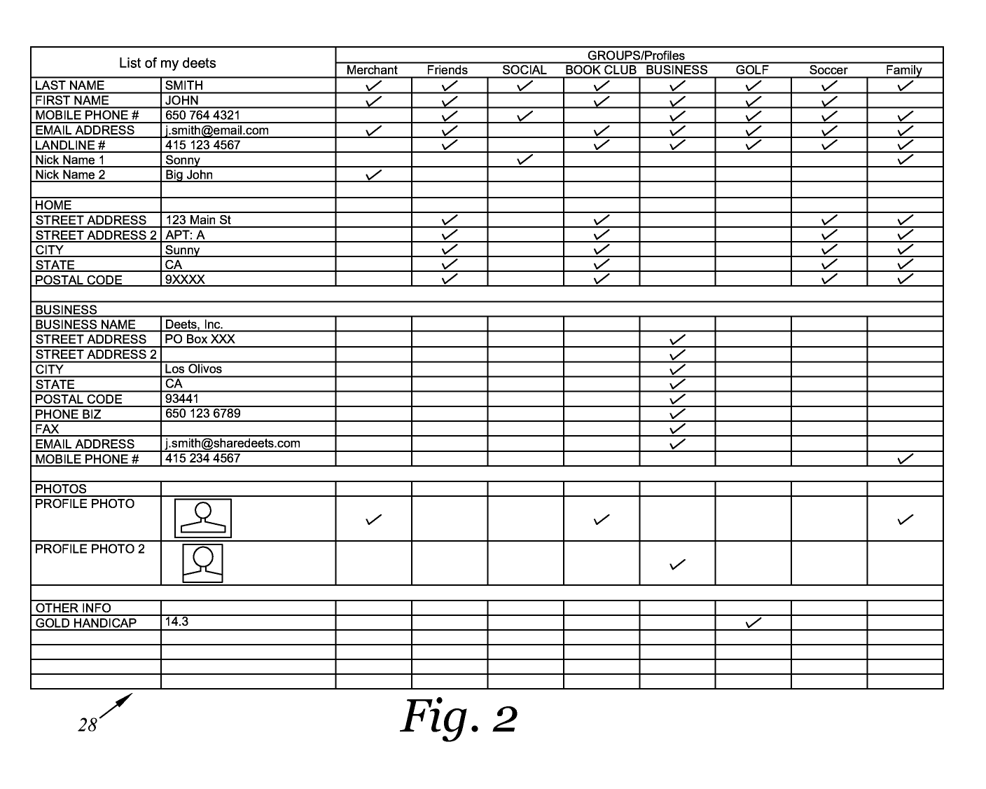

Having established the first user account, there is associated with the first user account a first user master profile with profile information elements. Referring now to FIG. 2 is an exemplary user interface 28 of the online networking platform for managing a user master profile, such as a first user master profile of the first user 30. The first user master profile is the aggregate collection of information associated with various defined data fields that may be representative of various data elements such as contact information and biographic information of the first user. In this example, data fields of the first user master profile include “LAST NAME,” “FIRST NAME,” “MOBILE PHONE,” “EMAIL ADDRESS,” “LANDLINE #,” “STREET ADDRESS,” and so forth. The profile information elements are those data elements associates with the data fields. These profile information elements includes “SMITH,” “JOHN,” “650 764 4321” and so forth. It is understood that the data fields need not be identical to those depicted and may be any number of data fields with associated naming conventions and acceptable formats for the profile information elements depending upon the utility of the online networking platform. In this regard, where the online networking platform is for the purpose of a business network, certain data fields would be expected to be pre-defined, such as various work contact information and business and educational experience. However where the purpose of the online networking platform is for the purpose of a specific social hobby, such as a car enthusiast related online networking platform, then certain other data fields may be more appropriate, such as descriptions of vehicles owned and locations travelled to. The first user master profile may have certain pre-defined data fields such as those illustrated along the left vertical axis. However, it is contemplated that the data fields may be user defined or a combination of both.

The online networking platform is configured to allow the first user 30 to establish and/or join one or more groups. Those users other than the first user 30 that are in the group would be a group member. In this regard as used herein the terms “first user” and “group member” are relative terms as in relation to the first user and those groups which the first user 30 is a part of. Referring now to FIG. 5 there is depicted a symbolic relational diagram of a group 32 that includes the first user 30 and the users 34a-g. From the perspective of the first user 30, the users 34a-g are group members. In the context of the first user master profile of FIG. 2, the group 32 may correspond to the group “Friends”.

It is contemplated that the formation of a group may be in accordance with various conditions. In an embodiment, a group may be formed only by the first user 30 as unilaterally determined by the first user 30. The first user 30 may selectively establish various other users as being group members in a specific group. The first user 30 may associate a group name for the first user's own edification. In this regard, the selected user may not be notified of such selection. This would facilitate the first user 30 to personalize and/or organize the contacts (such as those other users which the first user is linked or otherwise affiliated with). In another embodiment, the first user 30 may initiate invitations to other users to accept joining the group of the first user and the various invited users only become members upon taking some affirmative action to accept the invitation. This may be in response to an electronic notification via the online networking platform and accepting users having to click an electronic button or link so as to initiate a responsive signal to the online networking platform. In another embodiment, the first user 30 may establish the group as being “open” with other users being able to opt-in of their own accord to become group members.

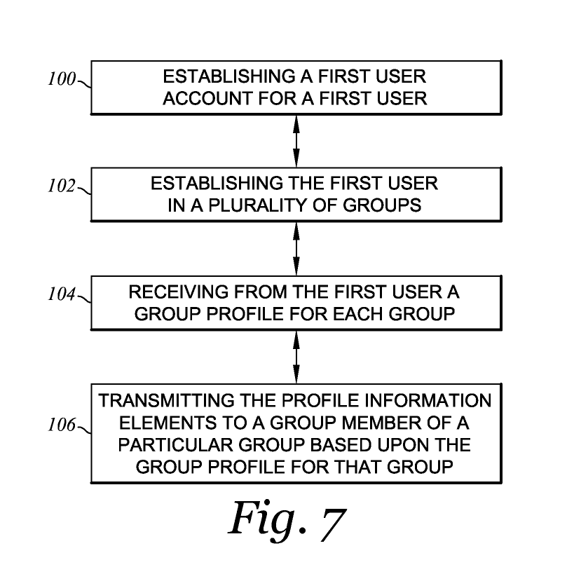

Referring now to FIG. 7 there is depicted a flowchart illustrating a method for selectively providing profile information in accordance with one embodiment of the present disclosure. In accordance with various embodiments of the present disclosure, there is provided a method for selectively providing profile information. The method includes establishing 100 a first user account for the first user 30 via an online networking platform. The first user account includes a unique account identifier and a first user master profile with profile information elements. The method further includes establishing 102, via the online networking platform, the first user 30 in a plurality of groups. Each group includes multiple group members. The method further includes receiving 104 from the first user 30, via the online networking platform, a group profile for each group to be accessible to group members for each group. Each group profile is a designation of any of the profile information elements. Each group profile includes a user name identifier. Each user name identifier is independent of another user name identifier. The method further includes transmitting 106, from the online networking platform, the profile information elements to a group member of a particular group based upon the group profile for that group. It is contemplated that the forgoing method facilitates the sharing of unique profiles of the first user 30 with granular control over what is included in the profile shared with each of the group members based upon a given group.

In the example configuration of FIG. 1, the first user 30 may interact with the online networking platform by utilizing the communications device via the communications link 18 to transmit selections which are received by the server 12 via the network 14 for processing by the online networking platform. In this regard, the steps of establishing 100 a first user account, establishing 102 the first user 30 in a plurality of groups, and receiving 104 from the first user 30 a group profile may all be facilitated via such communications link 18. Further, the online networking platform may execute the step of transmitting 106 the profile information elements to a group members such as by using the communications link 22 to communicate with the member 34a via communications device 20 associated with the member 34a. However, it is understood that the first user 30 and the members 34a-f may interact with the online networking platform via various communications links and devices that such individuals may have access to utilizing to electronically connect to the network 14.

As indicated above, the method includes establishing 102, via the online networking platform, the first user 30 in a plurality of groups with each group including multiple group members. The online networking platform may be configured to allow the first user 30 to create and/or join any number of groups. In the example of FIG. 2, a first user master profile includes data fields for 8 groups with profile information elements indicating the groups as “Merchant,” “Friends,” “SOCIAL,” “BOOK CLUB,” “BUSINESS,” ‘GOLF,” “Soccer,” and “Family.” It is understood that the first user 30 has 8 groups that the first user 30 has established or has joined.

As depicted in FIG. 5 the first user 30 is included in the group 32 that also includes the users 34a-g. In the context of the first user master profile of FIG. 2, the group 32 may correspond to the group “Friends”.

As indicated above, the method further includes receiving 104 from the first user, via the online networking platform, a group profile for each group to be accessible to group members for each group. With continuing reference to FIG. 2, the group profile for the group 32/“Friends” is a designation of those profile information elements indicated by the check marks. In this example, the “Friends” group profile does not include any profile information elements associated with the “BUSINESS.” As such, group members of one group may be exposed to a different profile of the first user 30 than those group members of another group.

As mentioned above, each group profile includes a user name identifier. In the example of group 32/“Friends” the user name identifier is comprised of the profile information elements, “LAST NAME” corresponding to “SMITH” and “FIRST NAME” corresponding to “JOHN.” Each user name identifier is independent of another user name identifier for the various groups. In the example of FIG. 2, with regard to the group “SOCIAL,” the user name identifier for such group is comprised of the profile information elements, “LAST NAME” corresponding to “SMITH” and “Nick Name 1” corresponding to “Sonny.” It is understood that the exemplary user interface 28 is configured to facilitate an ease of selection of various profile information elements for inclusion of a given group profile.

As indicated above, the method further includes transmitting 106, from the online networking platform, the profile information elements to a group member (such as any of those users 34a-g) of a particular group 32 based upon the group profile for that group 32. Significantly by the forgoing method, the first user 30 may be “known” to the group members of one group by a certain user name identifier and “known” to the group members of another group by another user name identifier. Every person interacts with other people in a variety of contexts. There may be any number of contexts by which interpersonal relationships dictate names by which individuals may be “known.” There are the obvious contexts like work, family and friends, but that really fails to cover the actual groupings into which the people in our lives fall. Work could include associates, immediate team, clients, suppliers, potential clients etc. Family could include “All family members”, “immediate family”, “spouse's family”. Friends could be “All social acquaintances”, “golf buddies”, “the book club”, “tennis team”, “east coast friends”, “high school friends”, those known via a maiden name/married name, etc. The information about one's self that is desirable to share is very different depending upon the group context. It may be desirable for people in the work context to have access to an office phone number while people in a social context may have access to a home or mobile number etc. Work associates may know a person as “H. Charles Smith” but a person's high school friends may only recognize such person as “Chas Smith” or family may know the person as “Sonny Smith”. An author or writer may simply be known in some groups by a nom de plume. Each is the same person, but the desired profile information elements to be shared with group members in a particular group or context, may be very different.

In the prior art, in order for a user of an online social networking website or platform to be known to other online contacts under different online user names, the user would have to establish entirely different user accounts. This has the drawback of not only having to manage different accounts but also to manage and track profile information and contacts associated with such differing accounts. Further, such profile information and contacts may be duplicative and require repeated data entry. Further still, simultaneous access to such multiple accounts may not be feasible where the particular communications device used to access the accounts does not support multiple simultaneous instances of the user interface or application (as in the typical case of smart phone).

According to various embodiments, the online networking platform may include a computer server in operable communication with a computer network. Further, the plurality of groups may include a first group and second group. The step of receiving from the first user may further include receiving a group profile for the first group and the second group with the first group including a user name identifier different than a user name identifier of the second group.

According to yet another embodiment, there is provided an article of manufacture comprising a non-transitory program storage medium readable by a data processing apparatus. The medium embodies one or more programs of instructions executable by the data processing apparatus to perform a method for selectively providing profile information as described above.

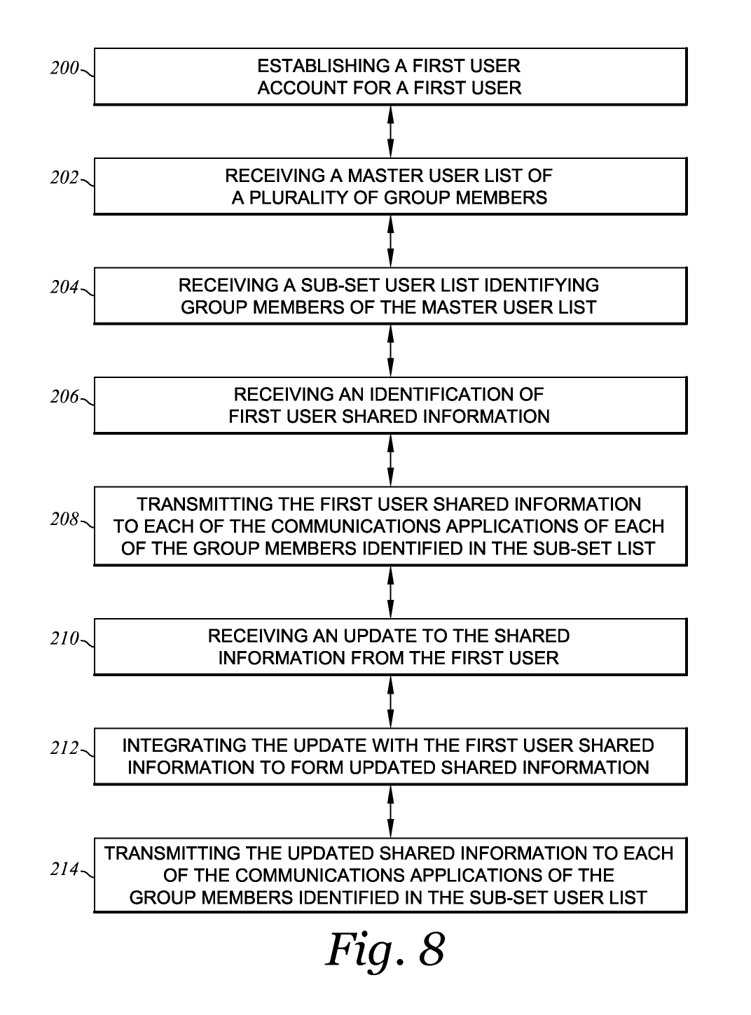

Referring now to FIG. 8 there is depicted a flowchart illustrating a method for dynamically updating profile information in accordance with one embodiment of the present disclosure. In accordance with various embodiments of the present disclosure, there is provided a method for dynamically updating profile information. The method includes establishing 200 a first user account for the first user 30 via an online networking platform. The first user account includes first user profile information. The method further includes receiving 202, via the online networking platform, a master user list of a plurality of group members. Each of the group members has a user account with the online networking platform. Each of the group members has an associated communications device. Each communications device includes a communications application and a native contact manager. Each communications application is configured to communicate with the online networking platform. The method further includes receiving 204, via the online networking platform, a sub-set user list identifying group members of the master user list. The method further includes receiving 206, via the online networking platform, an identification of first user shared information of the first user profile information from the first user and an associated sub-set user list of group members. The method further includes transmitting 208, from the online networking platform, the first user shared information to each of the communications applications of each of the group members identified in the sub-user list via a first communications protocol for storing the first user shared information with the native contact manager associated with each of the communications applications using a second communications protocol. The method further includes receiving 210, via the online networking platform, an update to the shared information from the first user 30. The method further includes integrating 212 the update with the first user shared information to form updated shared information. The method further includes transmitting 214, from the online networking platform in response to receiving the update the updated shared information to each of the communications applications of each of the group members identified in the sub-set user list via a first communications protocol for storing the updated shared information with the native contact manager associated with each of the communications applications using a second communications protocol.

It is contemplated that the forgoing method facilitates dynamically updating of the contact information in the native contact manager of a communications device of a group member. Shared information may be updated and “pushed” to a user's contacts (the group members of a group in which a user may belong). As a user may update his/her contact information, the forgoing method facilitates an ease of dissemination of such updated information in a selectable and controlled manner. Conversely, when a contact is a member of a group, the foregoing method allows the contact to have the latest contact information (as is shared by such contact), as it is automatically updated in the contact manager of the communications devices of the other group members. In this regard, a group member need not be required to check or verify the current status of a given contact through one or more online networking platforms and as compared against corresponding data elements stored in the communications device (native contact manager), such as a smart phone or the like.

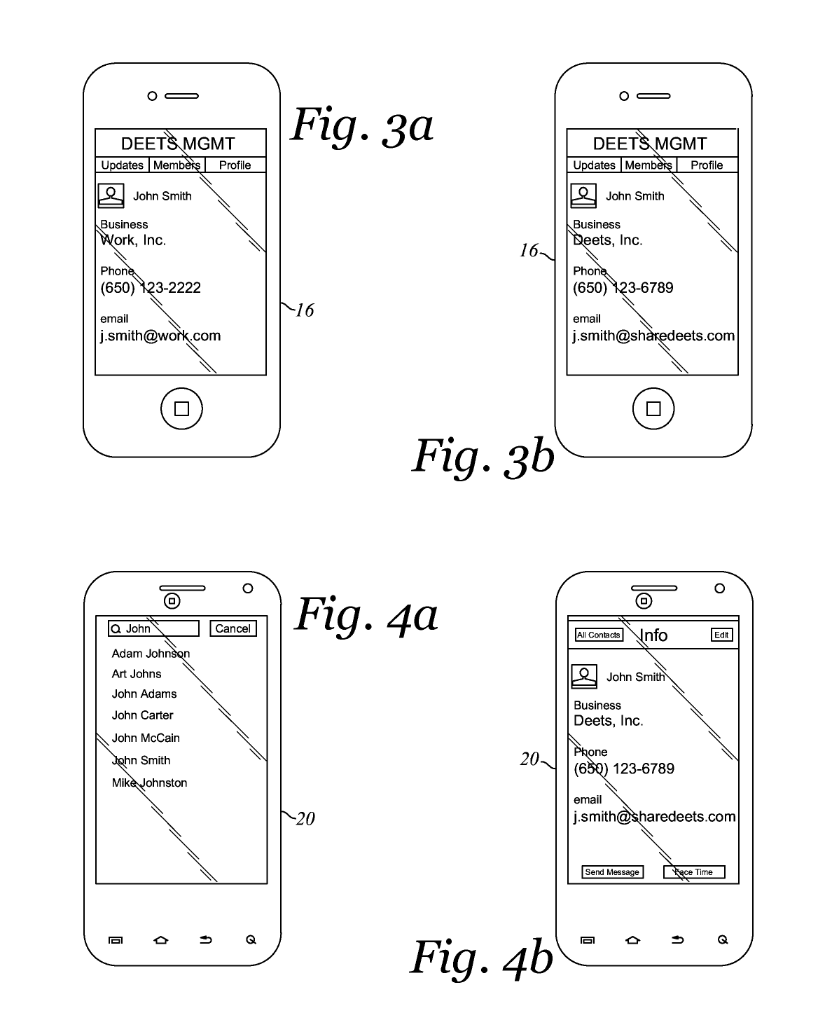

Referring now to FIG. 3, there is depicted an exemplary user interface of communications device 16 in the form of a mobile device of the first user 30 for viewing a user profile of the first user 30. FIG. 3b is the exemplary user interface of FIG. 3a with updated information being made to a user profile of the first user 30 with the updating of certain profile information element. In this regard, the profile information element of the “BUSINESS” is indicated as being updated from “Work, Inc.” to “Deets, Inc.” As mentioned above, the method further includes receiving 210, via the online networking platform, an update to the shared information from the first user 30. In this example, the profile information element of the “business” is updated by the first user 30 and is transmitted by the communications device 16 via the communications link 18 and received by the server 12 via the network 14 for processing by the online networking platform. As mentioned above, the method further includes integrating 212 the update with the first user shared information to form updated shared information.

As further mentioned above, the method further includes transmitting 214, from the online networking platform in response to receiving the update the updated shared information to each of the communications applications of each of the group members identified in the sub-set user list via a first communications protocol for storing the updated shared information with the native contact manager associated with each of the communications applications using a second communications protocol. Referring to FIG. 4a there is an exemplary user interface of the communications device 20 in the form of a mobile device of a user 34a. The user interface is exemplary of a contact search screen of a native contact manager of the communications device 20 with the user name identifier of “JOHN SMITH” associated with the first user 30 being indicated in the search results. FIG. 4b is the exemplary user interface of FIG. 4a with updated information being made to user profile of the first user 30 in the native contact manager of communications device 20 the user 34a. As such, the updated shared information is transmitted from the online networking platform to the network 14 to the communications device 20 via the communications link 22.

It is contemplated that the forgoing method facilitates the dynamic sharing of selected profile details to the group members of the group and updates the contact information associated with the first user 30 in the other group members native contact manager on their communications devices, such as their mobile devices or computers. Thus, updated changes to the first user profile information are immediately and privately communicated to the native contact manager of all group members thereby allowing such member to have the latest information at their ready disposal. This insures that the group members always have the relevant information about the updating first user 30 and that the information is always current and that first user 30 can have current information for each of the group members.

According to various embodiments, the online networking platform may include a computer server 12 in operable communication with a computer network 14. A group member may have an associated communications device that is a mobile device with a communications application configured to communicate with the online networking platform.

According to yet another embodiment, there is provided an article of manufacture comprising a non-transitory program storage medium readable by a data processing apparatus. The medium embodies one or more programs of instructions executable by the data processing apparatus to perform a method for dynamically updating profile information as described above.

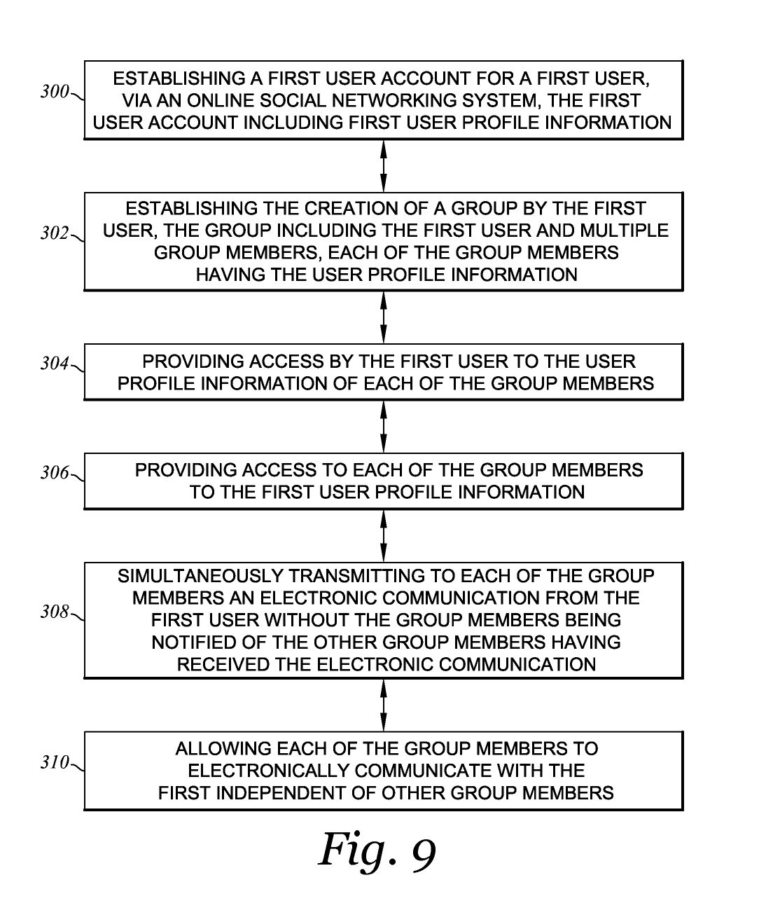

Referring now to FIG. 9 there is depicted a flowchart illustrating a method for communicating with group members in accordance with one embodiment of the present disclosure. In accordance with accordance to yet another embodiment, there is provided a method for communicating with group members. The method includes establishing 300 a first user account for a first user 30, via an online networking platform, the first user account including first user profile information. The method further includes establishing 302 the creation of a group by the first user 30, via the online networking platform, the group including the first user and multiple group members, each of the group members having user profile information. The method further includes providing 304 access, via the online networking platform, by the first user 30 to the user profile information of each of the group members. The method further includes providing 306 access, via the online networking platform, to each of the group members to the first user profile information. The method further includes simultaneously transmitting 308, from the online networking platform, to each of the group members an electronic communication from the first user 30 without the group members being notified of the other group members having also received the electronic communication. The method further includes allowing 310 each of the group members to electronically communicate, via the online networking platform, with the first user 30 independent of other group members.

Referring now to FIG. 6 there is depicted a symbolic relational diagram of an example group 32 that includes the first user 30 and the users 34a-g. From the perspective of the first user 30, the users 34a-g are group members. As is symbolically illustrated communications pathways are between the first user 30 and respectively between each of the users 34a-g. However, it is noted that there is no communications links indicated as between the users 34a-g themselves. In this regards, communications to and from each of the users 34a-g (the group members) are independent of each other.

In prior art online social networking applications, when an online group is formed, each member of the group is able to “see” who the other members of the group are and all of the information shared or communicated by other members of the group. The online networking platform utilizing method discussed above in accordance with aspects of the present invention has created a new facility for supporting groups where the communication and sharing is from the creator (i.e., the first user 30) of the group to each of the members of the group and from a member back to the creator/first user 30. The other members of the group do not “see” who else is in the group nor do they receive the shared information that is communicated from a member of the group to the creator of the group. In this regard, the method is an organizational tool that is unilaterally used by the first user 30 while maintaining a degree of privacy with regard to communications and the nature of the group membership. This is very useful in instances where there is a shared interest or focus for the group (the group as defined by the first user 30).

While in certain business contexts, the “office group” or a “project team” would be constructs where it might be expected to the cross sharing of contact information and other relevant information between all of the members of the group. Athletic teams, books clubs, social clubs, new mothers club, fraternities and sororities are other examples of where this type of group structure and the digital sharing of contact and other communications. However, there are other groups with whom people have relationships where that cross sharing of information is inappropriate and/or detrimental but where there is a desire to have the current contact formation of each group member and a desire to have each group member have the group organizer's contact information (all while not have each of the group members having knowledge of the other group members or visibility to information shared between group organizer and respective group members. The method described above supports such group interactions while the prior art online social networking systems do not.

In a certain business context “the clients” could be such a group. In a personal context, ex-girlfriends could be such a group. Clearly in both instances there may be a desire to have current and correct profile or contact details for the participants in the group and to insure that they have correct and current profile information for organizer of such a group (i.e., the first user 30). There may instances when the first user 30 may desire to communicate to the group members as a group and to receive communications from them on your mobile device. However, it might be detrimental and not in the best interest of the first user 30 to have the group members aware of the other members of that group or to receive communications to and from such other members.

According to various embodiments, the online networking platform may include a computer server 12 in operable communication with a computer network 14. The step of simultaneously transmitting may include initiating email communications to each of the group members from the first user 30 without the group members being notified of the other group members having also received the email communications.

According to yet another embodiment, there is provided an article of manufacture comprising a non-transitory program storage medium readable by a data processing apparatus. The medium embodies one or more programs of instructions executable by the data processing apparatus to perform a method for a method for communicating with group members as described above.

The particulars shown herein are by way of example and for purposes of illustrative discussion of the embodiments of the present disclosure only and are presented in the cause of providing what is believed to be the most useful and readily understood description of the principles and conceptual aspects. In this regard, no attempt is made to show details of the present invention with more particularity than is necessary, the description taken with the drawings making apparent to those skilled in the art how the several forms of the present invention may be embodied in practice.

What is claimed is:

1. A method for selectively providing profile information, the method comprising:
establishing an first user account for a first user via an online networking platform, the first user account including a unique account identifier and a first user master profile with profile information elements;
establishing, via the online networking platform, the first user in a plurality of groups, each group including multiple group members;
receiving from the first user, via the online networking platform, a group profile for each group to be accessible to group members for each group, each group profile being a designation of any of the profile information elements, each group profile including a user name identifier, each user name identifier being independent of another user name identifier; and
transmitting, from the online networking platform, the profile information elements to a group member of a particular group based upon the group profile for that group.

2. The method of claim 1 wherein the online networking platform includes a computer server in operable communication with a computer network.

3. The method of claim 1 wherein the plurality of groups includes a first group and second group, the step of receiving from the first user further includes receiving a group profile for the first group and the second group, the first group includes a user name identifier different than a user name identifier of the second group.

4. A method for dynamically updating profile information, the method comprising:
establishing a first user account for a first user via an online networking platform, the first user account including first user profile information;
receiving, via the online networking platform, a master user list of a plurality of group members, each of the group members having a user account with the online networking platform, each of the group members having an associated communications device, each communications device including a communications application and a native contact manager, each communications application being configured to communicate with the online networking platform;
receiving, via the online networking platform, a sub-set user list identifying group members of the master user list;
receiving, via the online networking platform, an identification of first user shared information of the first user profile information from the first user and an associated sub-set user list of group members;
transmitting, from the online networking platform, the first user shared information to each of the communications applications of each of the group members identified in the sub-user list via a first communications protocol for storing the first user shared information with the native contact manager associated with each of the communications applications using a second communications protocol;
receiving, via the online networking platform, an update to the shared information from the first user;
integrating the update with the first user shared information to form updated shared information; and
transmitting, from the online networking platform in response to receiving the update, the updated shared information to each of the communications applications of each of the group members identified in the sub-set user list via a first communications protocol for storing the updated shared information with the native contact manager associated with each of the communications applications using a second communications protocol.

5. The method of claim 1 wherein the online networking platform includes a computer server in operable communication with a computer network.

6. The method of claim 1 wherein a group member having an associated communications device that is a mobile device with a communications application configured to communicate with the online networking platform.

7. A method for communicating with group members, the method comprising:
establishing a first user account for a first user, via an online networking platform, the first user account including first user profile information;
establishing the creation of a group by the first user, via the online networking platform, the group including the first user and multiple group members, each of the group members having user profile information;
providing access, via the online networking platform, by the first user to the user profile information of each of the group members;
providing access, via the online networking platform, to each of the group members to the first user profile information;
simultaneously transmitting, from the online networking platform, to each of the group members an electronic communication from the first user without the group members being notified of the other group members having also received the electronic communication; and
allowing each of the group members to electronically communicate, via the online networking platform, with the first user independent of other group members.

8. The method of claim 7 wherein the online networking platform includes a computer server in operable communication with a computer network.

9. The method of claim 7 wherein the step of simultaneously transmitting includes initiating email communications to each of the group members from the first user without the group members being notified of the other group members having also received the email communications.

10. An article of manufacture comprising a non-transitory program storage medium readable by a data processing apparatus, the medium embodying one or more programs of instructions executable by the data processing apparatus to perform a method for selectively providing profile information, the method comprising:
establishing a first user account for a first user via an online networking platform, the first user account including a unique account identifier and a first user master profile with profile information elements;
establishing, via the online networking platform, the first user in a plurality of groups, each group including multiple group members;
receiving from the first user, via the online networking platform, a group profile for each group to be accessible to group members for each group, each group profile being a designation of any of the profile information elements, each group profile including a user name identifier, each user name identifier being independent of another user name identifier; and
transmitting, from the online networking platform, the profile information elements to a group member of a particular group based upon the group profile for that group.

11. The article of manufacture of claim 10 wherein the online networking platform includes a computer server in operable communication with a computer network.

12. The article of manufacture of claim 10 wherein the plurality of groups includes a first group and second group, the step of receiving from the first user further includes receiving a group profile for the first group and the second group, the first group includes a user name identifier different than a user name identifier of the second group.

13. An article of manufacture comprising a non-transitory program storage medium readable by a data processing apparatus, the medium embodying one or more programs of instructions executable by the data processing apparatus to perform a method for dynamically updating profile information, the method comprising:
establishing a first user account for a first user via an online networking platform, the first user account including first user profile information;
receiving, via the online networking platform, a master user list of a plurality of group members, each of the group members having a user account with the online networking platform, each of the group members having an associated communications device, each communications device including a communications application and a native contact manager, each communications application being configured to communicate with the online networking platform;
receiving, via the online networking platform, a sub-set user list identifying group members of the master user list;
receiving, via the online networking platform, an identification of first user shared information of the first user profile information from the first user and an associated sub-set user list of group members;
transmitting, from the online networking platform, the first user shared information to each of the communications applications of each of the group members identified in the sub-user list via a first communications protocol for storing the first user shared information with the native contact manager associated with each of the communications applications using a second communications protocol;
receiving, via the online networking platform, an update to the shared information from the first user;
integrating the update with the first user shared information to form updated shared information; and
transmitting, from the online networking platform in response to receiving the update, the updated shared information to each of the communications applications of each of the group members identified in the sub-set user list via a first communications protocol for storing the updated shared information with the native contact manager associated with each of the communications applications using a second communications protocol.

14. The article of manufacture of claim 13 wherein the online networking platform includes a computer server in operable communication with a computer network.

15. The article of manufacture of claim 13 wherein a group member having an associated communications device that is a mobile device with a communications application configured to communicate with the online networking platform.

16. An article of manufacture comprising a non-transitory program storage medium readable by a data processing apparatus, the medium embodying one or more programs of instructions executable by the data processing apparatus to perform a method for communicating with group members, the method comprising:
establishing a first user account for a first user, via an online networking platform, the first user account including first user profile information;
establishing the creation of a group by the first user, via the online networking platform, the group including the first user and multiple group members, each of the group members having user profile information;
providing access, via the online networking platform, by the first user to the user profile information of each of the group members;
providing access, via the online networking platform, to each of the group members to the first user profile information;
simultaneously transmitting, from the online networking platform, to each of the group members an electronic communication from the first user without the group members being notified of the other group members having also received the electronic communication; and
allowing each of the group members to electronically communicate, via the online networking platform, with the first user independent of other group members.

17. The article of manufacture of claim 16 wherein the online networking platform includes a computer server in operable communication with a computer network.

18. The article of manufacture of claim 16 wherein the step of simultaneously transmitting includes initiating email communications to each of the group members from the first user without the group members being notified of the other group members having also received the email communications.
